(19) United States
(12) Patent Application Publication
(10) Pub. No.: US 2019/0102787 A1
(43) Pub. Date: Apr. 4, 2019

(54) PRIZE OFFERING AND CLAIMING USER INTERFACE

(71) Applicant: T-Mobile USA, Inc., Bellevue, WA (US)

(72) Inventors: Ahmad O. Alkabra, Newcastle, WA (US); Bradley Smith, Bothell, WA (US); Martin Glenn, Seattle, WA (US)

(21) Appl. No.: 15/911,944

(22) Filed: Mar. 5, 2018

Related U.S. Application Data
(60) Provisional application No. 62/567,622, filed on Oct. 3, 2017.

(51) Int. Cl. G06Q 30/02

(52) U.S. Cl. CPC G06Q 30/0223; G06Q 30/0215; G06Q 30/0239

(57) ABSTRACT

Systems and method for providing staggered offers to a group of users are discussed herein. The system can receive an offer from a partner, which can include a maximum distribution rate (MDR) or a desired time over which the offer will run. Based on the MDR or the desired time, the group of users can be divided into an appropriate number of subgroups, with each subgroup receiving the offer during their respective time period. The system can enable users to receive, claim and redeem offers via a variety of user equipment (UE). Once claimed, an offer can be placed in an electronic prize wallet stored on the UE. The prize wallet can include offers that have been claimed, as well as details to enable the user to redeem the offer with the respective partner.

### PRIORITY CLAIM AND CROSS-REFERENCE TO RELATED APPLICATIONS

This Application is a non-provisional of, and claims priority under 35 USC § 119(e) to, U.S. Provisional Patent Application No. 62/567,622, filed Oct. 3, 2017, of the same title, the entire contents of which is hereby incorporated by reference.

### BACKGROUND

Companies often work together to provide advertising, promotional materials, coupons, free merchandise, etc. This may be to introduce a new brand or product, for example, or to increase awareness for an existing brand or product. Companies can work together to increase exposure and decrease advertising costs. A bobble head giveaway at a ball game, for example, attracts fans to the game, but also provides exposure for the bobble head manufacturer and any associated sponsors.

Providing merchandise for giveaways can be mutually beneficial. Take, for example, a cellular provider working with product manufacturers. The manufacturers can provide merchandise to the cellular provider at a reduced, or no, cost to the provider. The cellular provider, in turn, can provide advertising to the manufacture at little, or no, cost. Thus, the cellular provider can use merchandise giveaways, buy-one-get-one coupons, and other promotions to drive traffic to the provider's website. The manufacturer, on the other hand, can increase sales, promote new products, and reduce excess inventory, among other things, at a reduced cost when compared to traditional advertising (e.g., buying print or online advertising outright).

A problem can occur, however, if these promotions are not properly administrated. In the past, due to limitations in technology, offers were often an all or nothing proposition. In other words, the same offer was made to an entire pool of customers. In addition, the offer commonly could (or had to be) redeemed by all customers at the same time or on the same day. This often led to demand that outstripped the ability of the partner to supply the product offered in the promotion. Five-hundred customers showing up at the same pizza shop on the same day for their free pizza, for example, is likely not sustainable.

In addition, offers are often preassigned to all users in a pool. In other words, the offers were made and then immediately assumed to be redeemed—regardless of whether the user actually made any effort to redeem the offer. Thus, the commitment required by the provider of the offer (e.g., the pizza shop) was far in excess of what was actually needed. This leads bar codes, coupons, or other redemption mechanisms—along with the administration required to provision them—to go to waste when users actually redeemed fewer offers than were created.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a flowchart depicting an example method for dividing users into a plurality of subgroups based on a maximum distribution rate (MDR) for a particular offer, in accordance with some examples of the present disclosure.

FIGS. 2A-2C depict a plurality of graphical user interfaces (GUIs) to enable users to view, review, and claim offers, in accordance with some examples of the present disclosure.

FIG. 3 is another GUI for reviewing current and future offers, in accordance with some examples of the present disclosure.

FIGS. 4A-4C depict additional GUIs for reviewing past (FIG. 4A), current (FIG. 4B), and expired (FIG. 4C) offers, in accordance with some examples of the present disclosure.

FIG. 5 is a flowchart that depicts an example of a method for validating requests to claim offers, in accordance with some examples of the present disclosure.

FIGS. 6A and 6B are flowcharts that depict an example method for distributing a plurality of offers in a staggered fashion, in accordance with some examples of the present disclosure.

FIG. 7 is an example of a user equipment (UE) for use with the systems and methods disclosed herein, in accordance with some examples of the present disclosure.

FIG. 8 is an example of a server for use with the systems and methods disclosed herein, in accordance with some examples of the present disclosure.

### DETAILED DESCRIPTION

Examples of the present disclosure relate to systems and methods for providing various promotional offers. The system can stagger offers to groups of users to prevent overloading partners. The system can also dynamically assign offers to users as they redeem them, instead of automatically assigning one offer to all users. The system can provide a claiming mechanism, which enables user to indicate an interest in the offer, and a redemption mechanism to enable the user to actually receive the offer. In some examples, the claiming mechanism and redemption mechanism can be linked, such that they must occur within a particular geographical area or with a predetermined amount of time.

For ease of explanation, the systems and methods disclosed herein are discussed with reference to a provider and a partner. The provider is discussed as a cellular or internet service provider, but could also be an advertising agency, software company, cell phone manufacturer, or other entity with ready access to TV, internet, radio, wired or wireless telephone, or other media outlets. The partners are discussed with reference to restaurants, movie theaters, and grocery stores, but could be any supplier that provides goods and/or services in the marketplace. To this end, the description provided below is offered merely as examples of potential uses of the systems and methods and is not intended to be limiting.

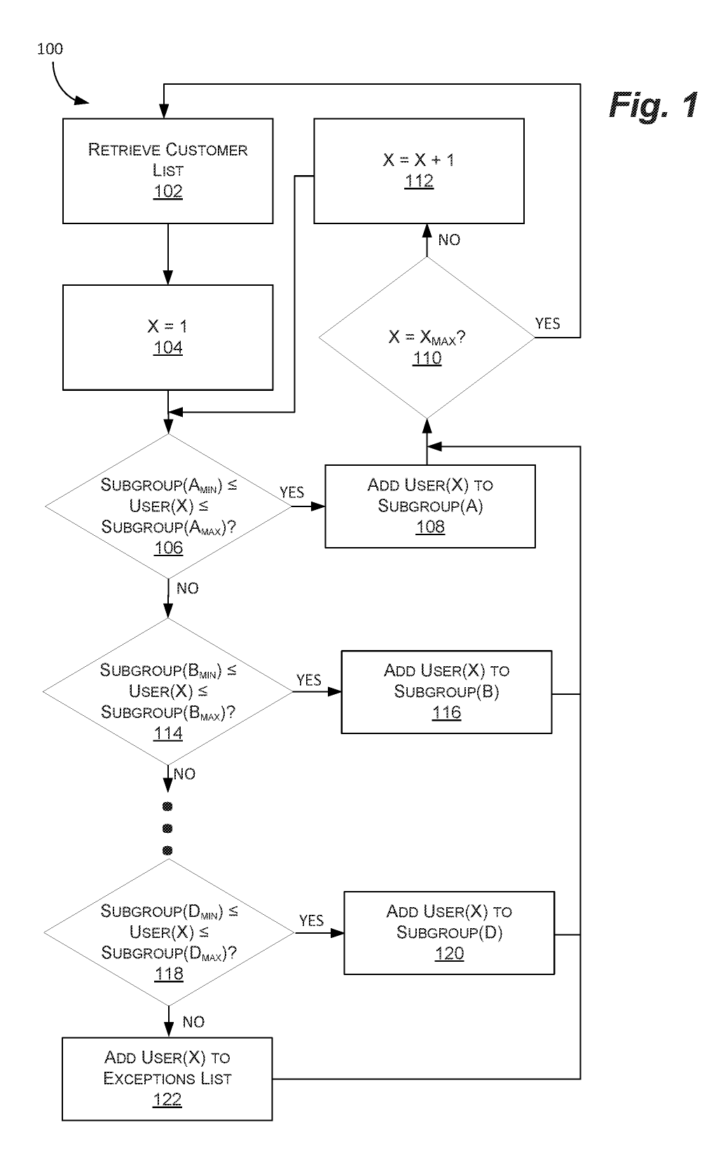

As shown in FIG. 1, in some examples, the system can include a method 100 for dividing all (or a subset of) users of a particular provider into relevant subgroups. The subgroups can enable the system to provide offers to users in a staggered manner (e.g., an offer is provided to one subgroup per week) to avoid overwhelming the partner associated with the offer. If one quarter of the users (as opposed to all of the users) are offered a particular offer (e.g., a buy-one-get-one (BOGO) pizza deal) in week 1, for example, this reduces the number of offers by 75% in a given time period (when compared to simply making a bulk offer to all users). Thus, the number of potential redemptions (in this case pizzas) is also reduced by 75% for that time period, significantly reducing the potential load on the partner.

This configuration also increases both the provider's and the partner's “bang for the buck.” In other words, because the same number of offers is spread out over four weeks, instead of offering them all at the same time, the partner is provided with a four-week promotional period for the same potential cost. Thus, demand can be managed at more reasonable level, while increased exposure is also provided.

In some examples, the system can also spread each offer out over a given time period (a week, for example), instead of forcing all users to redeem the offer on the day the offer is made. So, for example, the first offer can be made on Tuesday in week 1 and expire the following Tuesday when the second offer can be made. This further spreads the demand out over the week.

In some examples, the system can also limit the number of offers that can be redeemed per day. So, if a particular offer can be redeemed a maximum of 500 times per day, a user that misses this cutoff may receive a message that says all offers for the day have been claimed, and to please try again tomorrow. This can not only regulate demand for the offer, but also increase traffic to the provider's website—i.e., because the late user will visit the website or app at least twice. In still other examples, the offer may be claimed that day, but cannot be redeemed until some future date. In this configuration, all offers can be claimed on the first day (e.g., Tuesday), but only a limited number of offers can be redeemed (e.g., actually receive a free pizza) each day.

The method 100 can divide the total number of users into any number of subgroups. The size of each subgroup can be based on the needs of the partner, technological limitations (e.g., the ability to generate or distribute redemption bar codes), or other factors. And, while the method 100 is discussed herein as dividing customers into subgroups based on the last two digits of their customer number, the method 100 could also use addresses, phone number, customer preferences, other customer information, or simply random division to create the needed subgroups.

At 102, the method can begin by retrieving a list of customer numbers. The list can include all users, for example, or a subset of users who have signed up for offers, are members of a promotional website, etc. The list can be retrieved from a user database stored on a server or cloud service associated with the provider. So, for example, the list can comprise a list of the provider's customers that have downloaded an application (“app”) to their user equipment (“UE”), which can include, for example, a cell phone, smart phone, tablet, or laptop computer, among other things.

At 104, the method 100 can set a counter to 1 to cycle through the list, with 1 corresponding to the first user on the list, 2 corresponding to the second user on the list, etc. Thus, the method 100 can start with the first user on the list, User(1), and end with the last user on the list, User(Max). This is useful because, even though the list may be in customer number order, customer numbers may nonetheless be somewhat out of sequence due to account closures and other gaps in the customer numbers.

At 106, the method can determine if the first user, User(1) is within the range for the first subgroup on the list. In some cases, this could be users with a customer number that ends in 0-24, for example. In other examples, as mentioned above, this could be based on the user's phone number, address, preferences, or other information. Indeed, in some examples, the method 100 can simply randomly divide the list into the desired number of subgroups.

At 108, if the user is within the range for Subgroup(A), the user can be added to a list for Subgroup(A). In this case, if the user's customer number ends in 0-24, then the user can be added to Subgroup(A) and the method 100 continues iteratively. At 110, the method 100 can determine if the whole list has been sorted—i.e., if X=X_{MAX}. If so, the method 100 is complete and all users have been sorted. The method 100 can stop or can repeat for a second offer by returning to the customer list at block 102 to sort the customer list into different subgroups—e.g., for an offer running over a different time period. At 112, if not, the counter, X, can be incremented by one, which in this case will sort next User(2) into the appropriate subgroup by returning to block 106.

The method can be continued iteratively until all users have been sorted into a subgroup. As indicated by the dots in FIG. 1, therefore, in this case the method 100 can check each user to see if they should be sorted into Subgroup(A), Subgroup(B) (not shown), Subgroup(C) (not shown), or Subgroup(D).

After 106, therefore, if the user, User(1), does not fall within the range for Subgroup(A), the method 100 can determine whether User(1) falls within the range for Subgroup(B), Subgroup(C), or Subgroup(D). In some cases, this can be based on the user's customer numbers, for example, to create four subgroups—A—0-24, B—25-49, C—50-74, and D—75-99. Of course, as mentioned above, other metrics could be used instead of customer numbers and more or less subgroups could be created as needed.

To this end, at 114, if the user, User(1), does not fall within the range for Subgroup(A), the method 100 can determine whether User(1) falls within the range for Subgroup(B). If User(1) belongs to Subgroup(B), then at 116, the user can be added to Subgroup(B) and the method 100 again continues iteratively. At 110, therefore, the method 100 can again determine if the whole list has been sorted—i.e., if X=X_{MAX}. If so, the method 100 is complete and all users have been sorted. If X is not equal to X_{MAX}, the counter, X, can be incremented at 112 by one, which in this case will next sort User(2) into the appropriate subgroup.

At 118, if User(1) belongs to Subgroup(D), then the user can be added to Subgroup(D) at 120 and the method 100 again continues iteratively. At 110, therefore, the method 100 can again determine if the whole list has been sorted—i.e., if X=X_{MAX}. If so, the method 100 is complete and all users have been sorted. If X is not equal to X_{MAX}, the counter, X, can be incremented at 112 by one, which in this case will next sort User(2) into the appropriate subgroup.

At 122, if, for some reason, the User(1) does not fall within the ranges for any of the Subgroups, User(1) can be added to an exceptions list. This may be caused by corrupted data, a data entry error—e.g., a clerk entering a letter into the customer number by accident—a customer that is not eligible for the program, has opted out, has not paid their bill, etc. Regardless of the cause, the exceptions list can be reviewed periodically to correct errors and ensure all willing users are included in an appropriate subgroup. As before, at 110, the process can continue iteratively until all users have been sorted.

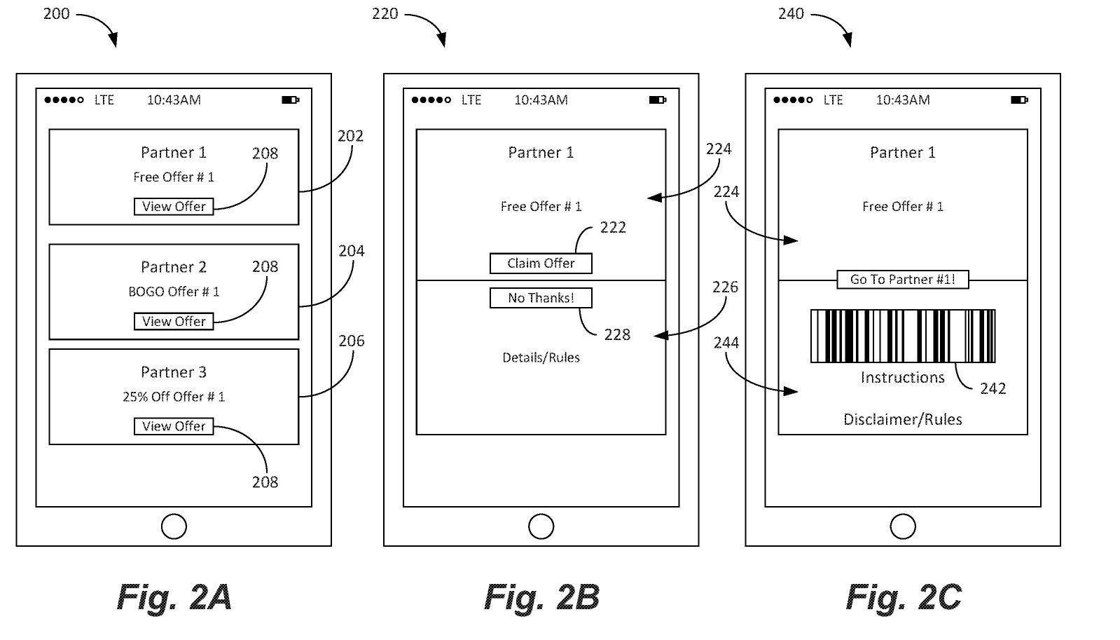

As shown in FIG. 2, examples of the present disclosure can also include GUIs suitable for users to review (FIG. 2A), claim (FIG. 2B), and redeem (FIG. 2C) offers. In these examples, the GUIs can be provided in an app or on a website, for example, on a cell phone or tablet (or another electronic device). The app can be provided by a cellular or internet service provider, for example, while the offers can be provided by partners.

As shown in FIG. 2A, in some examples, the first GUI 200 can provide multiple offers for the user to review. The first GUI 200 can include, for example, a first offer 202 from a first partner, a second offer 204 from a second partner, and a third offer 206 from a third partner. Of course, all of the offers 202, 204, 206 could be from a single partner or any number of partners. In addition, the offers 202, 204, 206 can be any type of offers—e.g., gifts, free offer, BOGO, coupons, etc.—based at least in part on the deal negotiated between the provider and the partners.

In some examples, as shown, the first offer 202 can be a free offer. In other words, no purchase or other action is necessary by the user, other than claiming and then redeeming the first offer. This could be an offer, for example, for a free pretzel, pizza, car wash, movie ticket, lawn service, or any other good or service. As mentioned above, due to the popularity of free offers and the cost in fulfilling them, it may be desirable to control the rate at which the first offer can be claimed.

To this end, in this case, the first GUI 200 displays the first offer 202 because the user is currently eligible for it. In other words, the user is in the subgroup currently scheduled to receive the first offer 202, the first offer 202 is still being offered (e.g., the user is within the date range of the first offer 202). In some examples, the first offer 202 may be available for a predetermined amount of time (e.g., minutes, days, weeks, etc.) until, for example, the first offer 202 expires for the user or the allotment of recipients for the first offer 202 has been claimed. So, the first offer 202 may be limited to 500 first offers 202 per day or 500,000 per week, for example, at which time the first offer 202 can be removed from the first GUI 200.

The first GUI 200 can also include a view button 208. The view button 208 can comprise a graphical, or virtual, button to enable the user to select the offers 202, 204, 206 and receive additional information. Of course, in other examples, the offers 202, 204, 206 can include numbers or letters to enable the user to select an offer by entering a number or letter on an actual or virtual keyboard.

Regardless, as shown in FIG. 2B, the second GUI 220 can enable the user to learn more about a particular offer. Thus, by selecting the view button 208 associated with the first offer 202, in this case, leads the user to the second GUI 220. The second GUI 220, in turn, can enable the user to learn more about the first offer 202 and to claim the first offer 202 with a claim button 222.

In some examples, the second GUI 220 can include a logo or description window 224 that provides details about the partner and the first offer 202. So, for example, the description window 224 can include the logo of the partner, the gift or deal that is offered—e.g., “Get a free small one-topping pizza”—and other slogans and advertising. This provides the partner with the desired advertising and name recognition while providing incentive to the user to download and use the app.

In some examples, the second GUI 220 can also include a details window 226. The details window 226 can include any additional details, rules, disclaimers, or other information related to the first offer 202. In some examples, the details window 226 can include one or more date ranges for the first offer 202. So, for example, the first offer 202 may be available to claim for the next week and available to redeem for the next month (or some other combination).

The second GUI 220 can also include the claim button 222. As the name implies, the claim button 222 can enable the user to actually claim the first offer 202 (as opposed to just reviewing it). As before, the claim button 222 can comprise a graphical, or virtual, button to enable the user to claim the first offer 202 and receive redemption information, discussed below with reference to FIG. 2C. Of course, in other examples, the description window 224 or details window 226 can include numbers or letters to enable the user to claim an offer by entering a number or letter on an actual or virtual keyboard. Indeed, in some examples, the user can claim the first offer 202 simply by touching the screen anywhere or any other acceptable interactive method.

Regardless of the mechanism, the user can claim the first offer 202. Significantly, as mentioned above, the first offer 202 is not removed from the pool of available first offers until the user actually claims it. Thus, the user can review all the offers 202, 204, 206 and then claim one or more, or none, of the offers. This reduces the number of offers to which the partner must agree and the number of offers that must be provisioned in the app by the provider.

In other words, in the past, if the app had 500,000 users, then the provider would obtain a commitment for 500,000 offers from the partner, generate 500,000 tokens (discussed below), etc. This resulted in large numbers of offers remaining unclaimed and excessive administrative costs, among other things. In this configuration, therefore, the offer is not attributed to the user until the user actively indicates a desire to claim it—by pressing the claim button 222.

In some examples, the second GUI 220 can also include a reject button 228. As the name implies, the reject button 228 can enable the user to actively reject the offer. In this manner, the user can be taken out of the pool of users that may potentially claim the offer, for example, rather than waiting until the offer expires. A large number of users may also signal to the provider and/or the partner a need to revise the offer mid-stream to make the offer more popular. Thus, rather than waiting until the offer expired to see how many users passively rejected the offer—by not claiming the offer—the provider and/or partner are provided with feedback while the offer is still active.

As shown in FIG. 2C, in response to the user pressing the claim button 222, a third GUI 240 is invoked. The third GUI 240 can include the description window 224 (or a new description window), a token 242, and an information window 244. The information window 244 may include the same or different information as the details window 226. The details window 226 may include basic information or rules, for example, while the information window 244 may provide specific instructions or rules related to redeeming the token 242.

The token 242 can comprise a mechanism to enable the user to actually redeem the first offer 202. The token 242 can comprise a bar code (shown), quick response (QR) code, digital coupon, alphanumeric code, or other means to enable the partner to verify the user as someone who has claimed the first offer 202. In some examples, the token 242 can simply comprise a “show and go” coupon. In this configuration, the user can simply show their UE to a cashier at the partner, for example, and the cashier can handle the discount, as required. This may be used, for example, for partners with less sophisticated technology or partners who are not concerned with how many offers are redeemed or who prefer to keep their own records separately from the app. In a highly profitable industry, for example, a BOGO offer may nonetheless be profitable for the partner, reducing any concern about fraud.

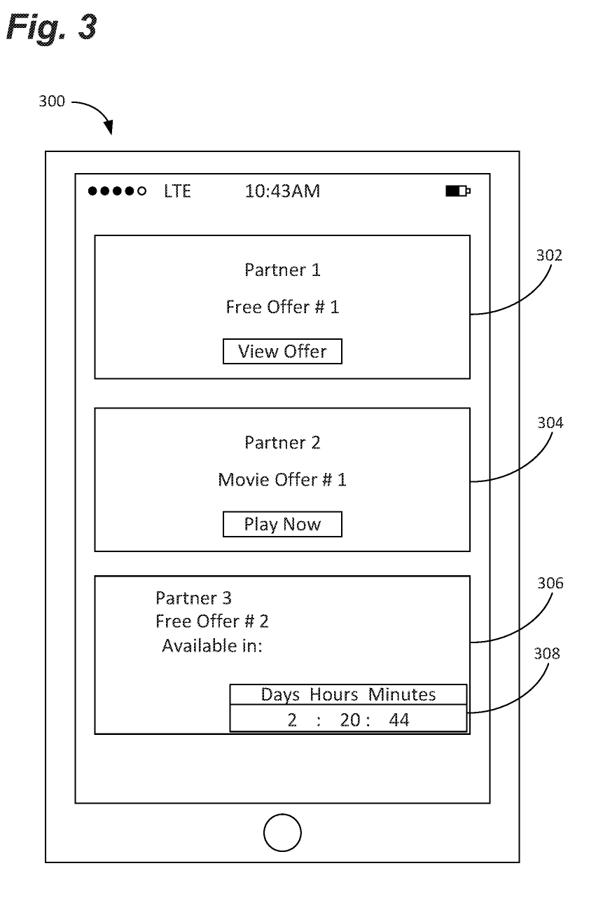

As shown in FIG. 3, the system can also comprise a GUI 300 that enables the user to review current offers 302, 304 and future offer(s) 306. Thus, as before, the GUI 300 can list a first current offer 302 and a second current offer 304 including those offers that are being currently offered to the user (e.g., the user is in the correct subgroup and the date for the offer is valid). In this configuration, however, the GUI 300 can also include a future offer 306.

As the name implies, the future offer 306 is an offer that is not yet available to the user. Thus, the user may be in a second subgroup during the first week of a promotion (i.e., where the offer has only been offered to the first subgroup thus far), for example, but will be in the “correct” subgroup the following week. To this end, the future offer 306 can also include a timer 308 to tell the user when the future offer 306 will be available.

For very popular offers, this may enable the user to plan to claim the offer early the following week. This can also pique the user's interest and keep the user coming back to the app to check for new deals as they appear, even when they are scheduled to be active in the future. Displaying future offers can also further extend the advertising value of the offer, increasing advertising value to the partner.

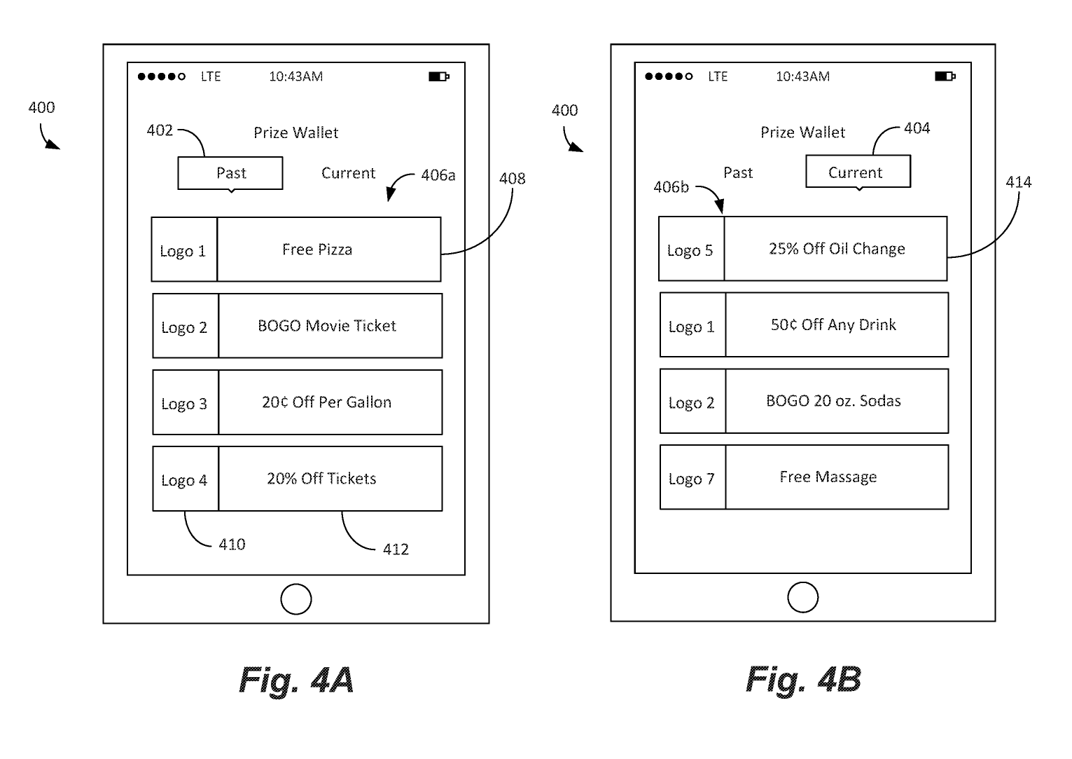

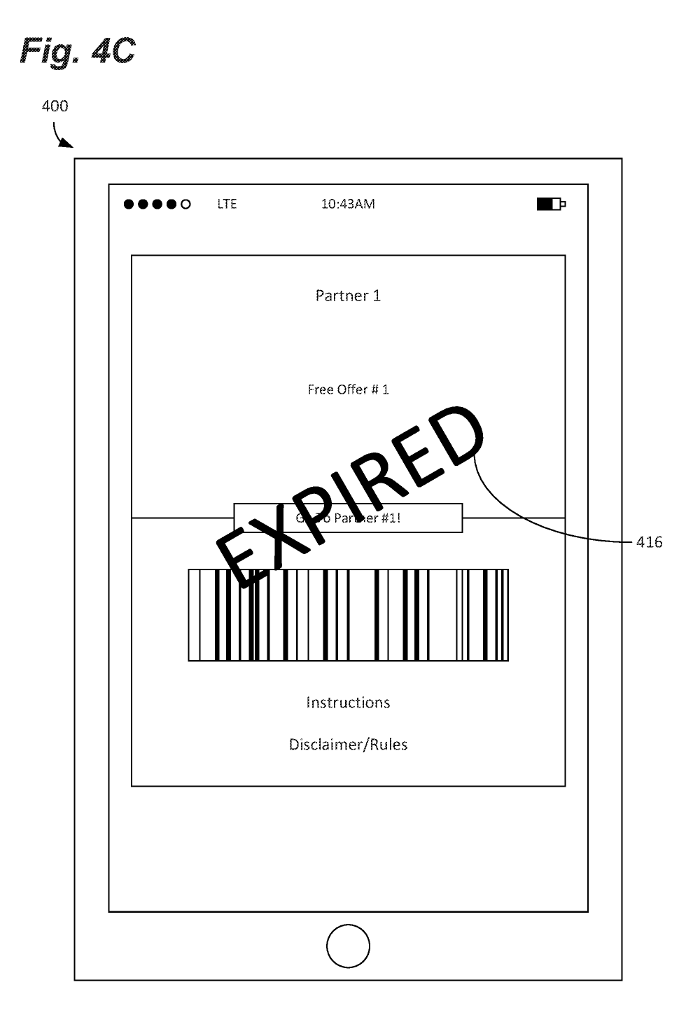

As shown in FIGS. 4A and 4B, the system can also include a prize wallet 400 to contain and organize the offers that the user has claimed. As shown, the prize wallet 400 can contain a history tab 402 (FIG. 4A) and a current tab 404 (FIG. 4B). Both tabs 402, 404 can include a list 406a, 406b of offers, with each offer contained in a selection box 408, 414. In both tabs, the offers can include various identifying information about the offer such as, for example, the logo 410 of the partner and a basic description 412 of the offer (e.g., free, BOGO, etc.). This can enable the user to quickly review past and pending offers. Indeed, reviewing past offers may remind the user of a particular partner and cause the user to return, even without an offer.

As shown in FIG. 4A, the history tab can include the offers that the user has claimed in the past. In some examples, the history tab can include all offers that have been claimed, regardless of whether the user actually redeemed the offer. In other examples, the history tab can include only those offers that the user actually redeemed, with the non-redeemed offers dropping out of the prize wallet 400 when the offer expires. So, for example, if a user claims an offer that must be redeemed within 24 hours, but doesn't actually redeem it, the offer can be removed from the prize wallet 400 twenty-four hours after the offer was claimed.

As shown in FIG. 4B, the prize wallet 400 can contain the offers that the user has claimed and that are still valid, or “current.” So, for example, if a user claimed a first offer, a selection box 414 for that offer can be placed in the list 406b of current offers. If the offer is for a 25% off of an oil change that doesn't expire for a month, for example, the selection box 414 for the offer can remain in the user's prize wallet 400 for a month until it has expired. In some cases, such as offers that can only be used once, once the offer is redeemed—i.e., the user receives their oil change—the selection box can be moved from the list 406b in the current tab 404 to list 406a in the history tab 402. Thus, offers can be moved from the current tab 404 to the history tab 402 based on expiration or redemption.

In some examples, by pressing a particular selection box 408, the user can be taken to a screen that includes additional information, redemption codes, etc. In some examples, choosing a selection box 408 can take the user to the third GUI 240, discussed above. In this configuration, touching a selection box 408 can provide the user with the description window 224 (or a new description window), a token 242, and an information window 244. As before, the information window 244 may provide specific instructions or rules related to redeeming the token 242 or redeeming the offer.

In some examples, the user can be taken to the third GUI 240 regardless of whether the selection box 408, 414 is on the history tab 402 or the current tab 404. In some examples, as shown in FIG. 4C, if the offer on the history tab 402 has expired, however, the third GUI 440 can include a notice 416 to remind users that they are looking at an expired or invalid offer. The notice 416 can comprise a watermark (shown) or a pop-up window, for example, when selection boxes 408 associated with offers on the history tab 402 are selected.

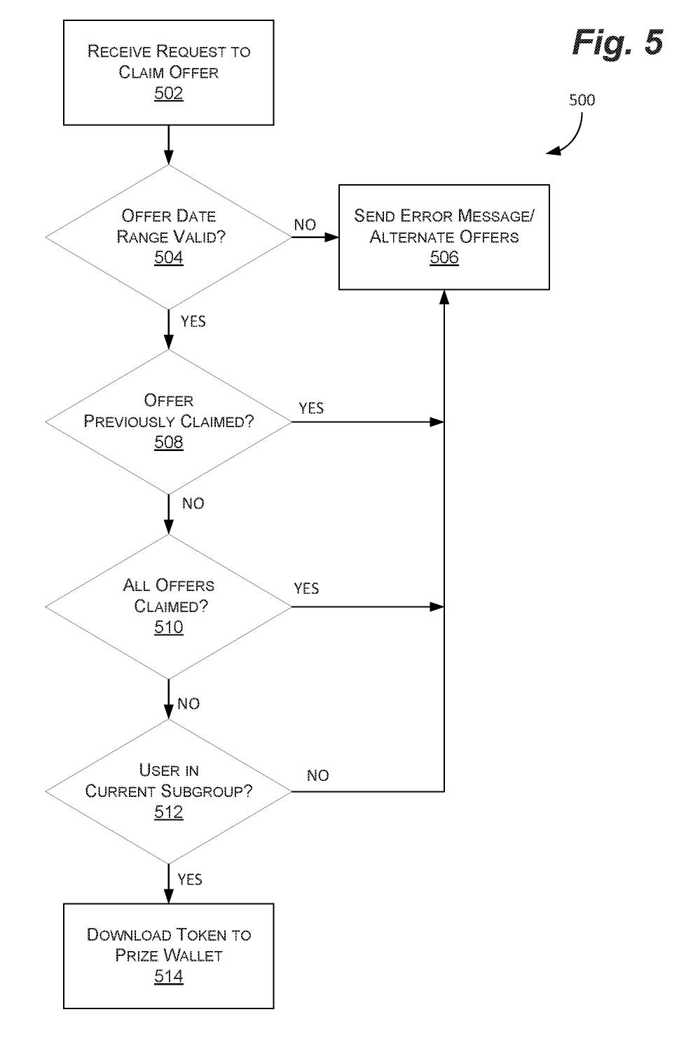

As shown in FIG. 5, examples of the present disclosure can also comprise a method 500 for managing the claiming process for offers. As discussed above, the offers can be staggered according to a desired date range or a maximum distribution rate (MDR), thus to claim an offer, the user can be confirmed as a valid user for a particular offer. Because the provider may be hosting multiple offers, each request to accept an offer may need to be checked to ensure multiple eligibility requirements are met.

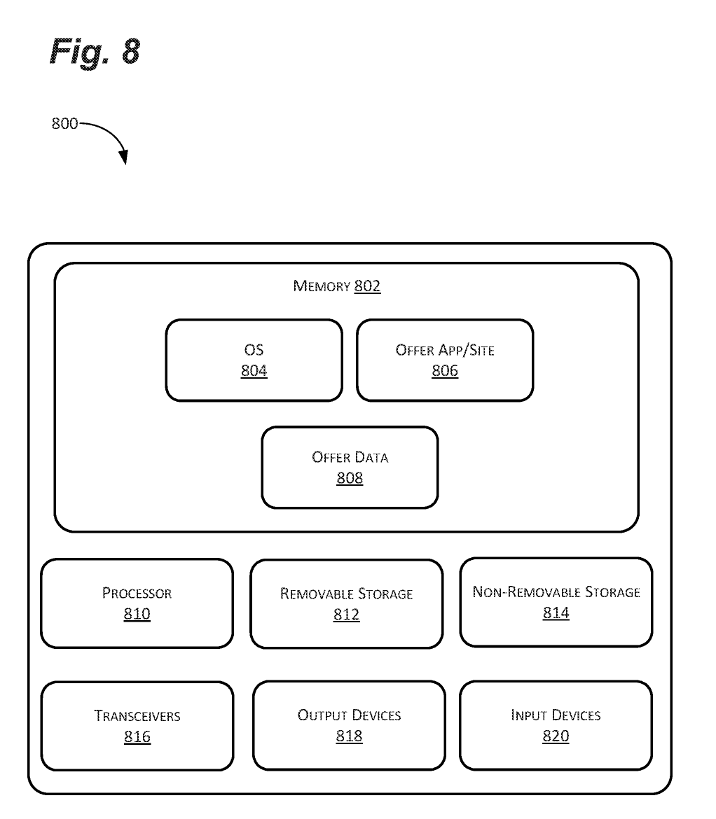

At 502, therefore, the method can begin by receiving a request to claim an offer from a user (or rather, a UE). The request can be received at a computer, server, cloud of servers, etc. configured to host the app, maintain user data, and/or maintain user prize wallets. The server can comprise, for example, the reward engine 800, discussed below with reference to FIG. 8. As discussed above, the request may be made in response to the user selecting the offer button 222, for example, on the second GUI 220.

At 504, the method 500 can determine if the requested offer is within a valid data range. In other words, if an offer was configured to run for a week and then week has passed, then the offer has “expired” and is no longer available. As mentioned, this can be based on a decision made by the provider in concert with the partner to stagger the offer over a predetermined date range (a day, a week, a month, etc.), among other things.

At 506, if the date range is invalid, then the user can be provided with an error message indicating that the requested offer has expired or is otherwise invalid. In some examples, the message can also include additional offers that are valid for the user based on the date, subgroup, etc. so the user is nonetheless provided with an opportunity to claim an offer. In some examples, the reward engine 800 can retrieve similar offers from an offer database. So, if the user was attempting to redeem a 25% off coupon for a small pizza, for example, the reward engine 800 may be able to provide a BOGO offer for pizza that is still available instead.

At 508, if the date range is valid, on the other hand, the method 500 can next check to see if the user has already claimed the requested offer. Thus, the reward engine 800 can consult the user's prize wallet 400 (or a database facsimile thereof) to determine if the user has previously claimed the same offer. Of course, as mentioned above, some offers may be claimed multiple times or may not have a limit. Depending on the offer, therefore, this step can verify the user has not exceeded the limit or can be obviated if there is no limit. If the user has already claimed the offer or has exceeded the limit, then at 506, the user can receive an error message and/or additional offers, as discussed above.

At 510, the method 500 can determine if all offers have already been claimed. In other words, in some example, an offer may be provided for less than the total number of users or the total number of users in a subgroup. These offers may be provided on a first-come-first-served basis and can conceivably “run out” before the end of the date range. This may be for particularly costly offers (e.g., Superbowl tickets) or to enable smaller partners to participate (e.g., partners that cannot afford to make two million offers). If all of the offers for the requested offer have already been claimed, then at 506 the user can receive an error message and/or additional offers, as discussed above.

At 512, if the offer is still available, on the other hand, the method 500 can next determine that the user is in the correct subgroup. As mentioned above, the users can be divided into an appropriate number of subgroups, with each subgroup receiving the offer at a different time and for a different time range (though theoretically, the date ranges could overlap somewhat). Thus, the method may require that the user be in the subgroup currently slated to receive the offer.

If the user is not in the correct subgroup, then at 506, the user can receive an error message and/or additional offers, as discussed above. In some cases, the user may also be provided with the dates during which the offer will be available to his/her subgroup. Thus, the user may receive a message that simply says, “This offer will be available on April 12, please check back!”

At 514, if the user meets all of the criteria for the requested offer, the offer can be downloaded to the user's prize wallet 400. As mentioned above, the user can be provided with the token 242 (or other redemption mechanism) and instructions or additional documentation needed for the user to actually redeem the offer. This can be provided in the third GUI 240 and can include additional information, as desired by the provider or partner.

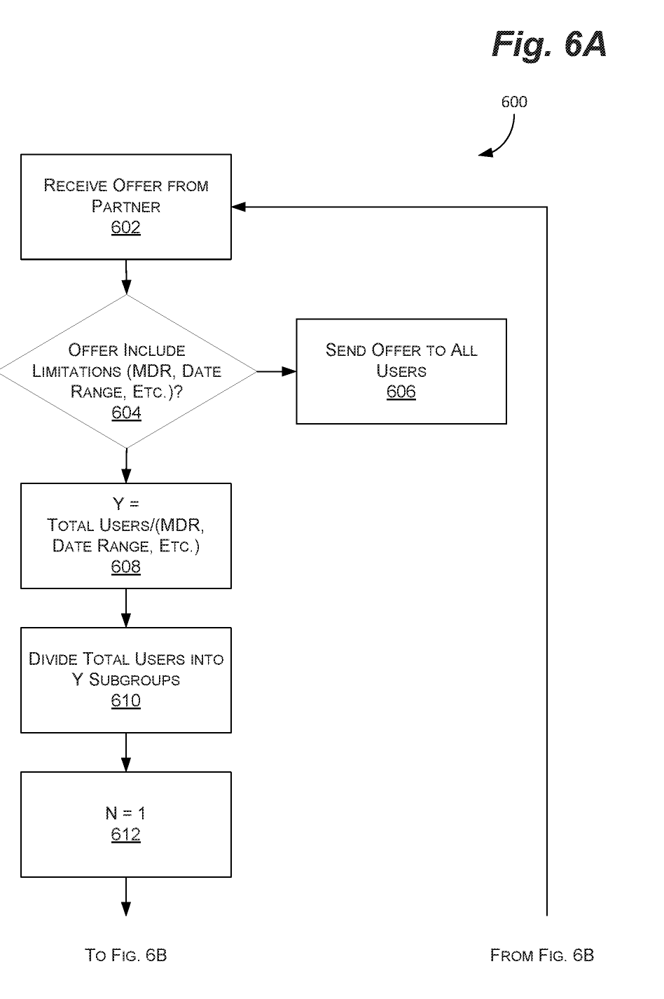

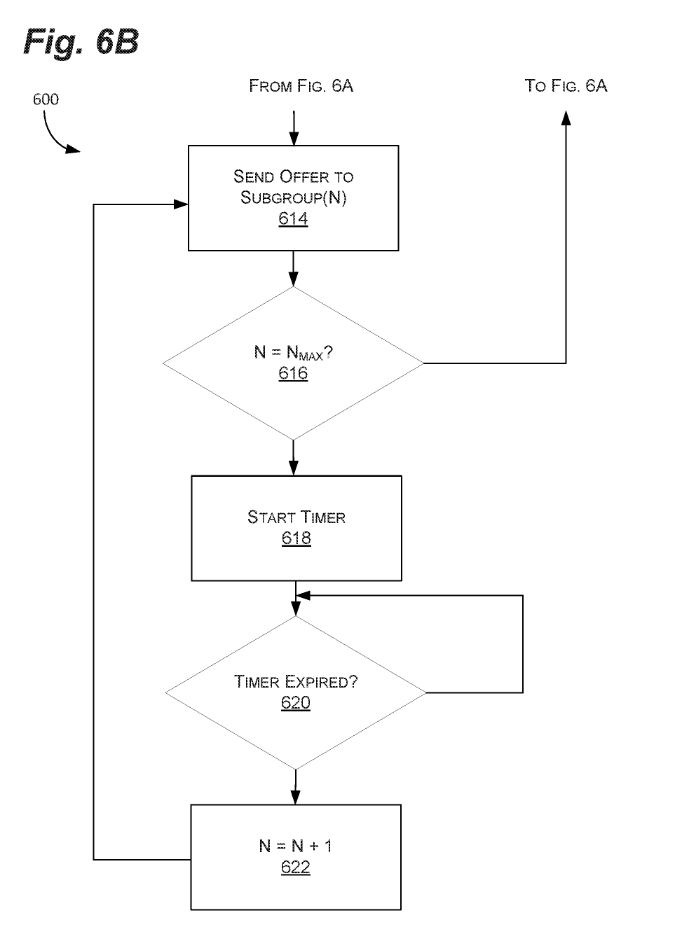

As shown in FIGS. 6A and 6B, examples of the present disclosure can also comprise a method 600 for receiving offers from partners and then distributing them accordingly. As discussed above, in some examples, the offers can be provided to users all at once. To avoid over-loading partners, however, in some examples, the offers can spread out over multiple days, weeks, or months. Of course, partners can also have input into how they would like to have a particular offer distributed (i.e., all at once, staggered, based on an in-app contest, etc.).

As shown in FIG. 6A, at 602, the provider can receive an offer from a partner. The offer can include the number of offers the partner would like to provide, any desired date ranges, and, if applicable, a distribution rate or MDR. In some examples, the partner may need to commit to at least enough offers for all of the provider's users (e.g., all customers or all customers who have signed up to receive offers, downloaded an app, etc.) to receive and/or redeem the offer. In other examples, the partner may need to commit to some percentage of the total users (plus some buffer) based on historical redemption rates from the provider. So, for example, if 25% of the users tend to redeem BOGO offers for pizza, then the partner may need to provide at least enough offers for 25% of the total user plus another 10% buffer.

The partner can also provide an MDR to the provider, from which an actual distribution rate (ADR) can be derived. In some examples, the ADR may be based on the MDR. In other words, the ADR is set purely to control the number of offers outstanding at any one time. Thus, for a provider with two million customers, for example, the partner may agree to two million offers distributed at an MDR of 500,000 per week. Thus, the ADR can be set to be equal to the MDR. Of course, other partners may not need or want an MDR, thus the partner can authorize all-at-once distribution, or simply leave it up to the provider to manage distribution rates.

In some examples, the ADR can be based solely on the date range specified by the partner or the provider. In other words, even in the case where the partner does not require an MDR, the method 600 can nonetheless create an ADR to spread the offer out over the desired date range. So, for example, if the offer is to be sent out once a week for four weeks, the method 600 can divide the users into four subgroups, one for each week. In sum, the ADR can be based on the MDR (e.g., 250,000/week) or the desired date range, among other things.

At 604, therefore, when the time to distribute the offer arrives, the provider can determine if the offer includes an MDR, a date range, or other limitations. If the offer does not include an MDR or date range, then at 606, the provider can send the offer to all users at the same time. In some examples, this can include adding the offer to the first GUI 200 (discussed above), sending e-mails or text to users, and/or adding the offer to the provider's website. Of course, even when no MDR is provided by the partner, the provider may nonetheless decide to assign an MDR to stagger the distribution of the offer based on the date range to increase exposure, reduce strain on infrastructure (e.g., the offer acceptance mechanism, discussed above), or to minimize wait times for users, among other things.

At 608, if, on the other hand, the offer does include an MDR and/or a date range, then the provider can next determine the number of subgroups, Y, needed. In the case of an MDR, the number of subgroups can be found by dividing the total number of users by the MDR. So, for example, if the MDR=500,000 per week and there are 2 million users, then the users can be divided into 4 subgroups (i.e., Y=4).

If the offer has a desired date range, on the other hand, then Y can be determined based on the date range. An offer that the partner or provider wants to offer to a subgroup every day for a week can be divided into seven subgroups (Y=7) one for each day. An offer that the partner or provider wants to offer to one subgroup a week for two months, on the other hand, can be divided into eight subgroups (Y=8).

At 610, regardless of how Y is derived, the provider can then divide the users into the appropriate number of subgroups using, for example, the method described above with respect to FIG. 1. As mentioned above, this can be done using the user's customer numbers, account numbers, phone numbers, address, user preferences, or any other convenient metric. In some examples, if the subgroups are uneven (e.g., the MDR does not divide evenly into the total number of users) any remainder can be added into an additional subgroup or an additional subgroup can be added to bring the ADR below the MDR for all subgroups. So, in one example, if there are 2 million users and the MDR is 300,000 per week, then the users can be divided into six subgroups of 300,000 and a seventh subgroup of 200,000. In another example, the users can be divided into seven equally sized subgroups of around 286,000 users. At 612, a counter, N, can be set to 1 denoting the first subgroup of the Y subgroups.

As shown in FIG. 6B, at 614, the offer can be sent to the users in subgroup(N), in this example, subgroup(1). Thus, the offer is sent out by adding the offer to the provider's website or app, sending out e-mails or texts, and/or other means. As mentioned, the subgroups enable the offer to be sent out at or below the MDR or over the desired date range, among other things. In addition, the offer can be spread out over a number of days, weeks, or months. In the example above, with seven subgroups, the offer can be sent out to a different subgroup, for example, every day for a week, every week for seven weeks, etc.

At 616, the method 600 can determine if the offer has been sent to all subgroups—e.g., if subgroup(N)=subgroup(N_{MAX}). If so, at 602, the method can continue by receiving another offer from the same, or a different, partner to continue the distribution process.

At 618, if not all subgroups have been provided the offer—e.g., subgroup(N)≠subgroup(N_{MAX})—then a timer can be set to provide the appropriate delay between the current subgroup (in this example, subgroup(1)) and the next subgroup (in this example, subgroup(2)). Thus, the time can be set for an hour, 24 hours, a week, a month, or any other value based on the ADR.

At 620, the method 600 can determine if the time is expired—i.e., if it is time to send the offer to the next subgroup. If not, the method 600 can simply wait, can perform other tasks unrelated to the current offer, or simply stand by. If, on the other hand, the time has expired, then at 622, the counter, N, can be incremented by one—e.g., N=N+1—to iterate to the next subgroup, in this case subgroup(2).

At 614, the method 600 returns to send the offer to subgroup(2) and the process continues until all subgroups have received the offer. At 616, the method 600 again checks to see if all subgroups have received the offer—e.g., if subgroup(N)=subgroup(N_{MAX}). If so, at 602, the method can continue by receiving another offer from the same, or a different, partner to continue the distribution process. If not, the method continues until all subgroups have received the offer.

Thus, the method 600 can take minutes, hours, days, or even months to complete. If an offer is to run over the course of a month, for example, the offer can be provided to four separate subgroups, one subgroup per week, as discussed above. In some examples, the users in the “on” subgroup during a particular week can receive a “major” offer, while the users in the “off” subgroups can receive a somewhat more “minor” offer from the same partner. So, for example, the “on” subgroup can receive a free pretzel, while the “off” subgroup receives a 25% off coupon. Or, the “on” subgroup can receive a BOGO coupon, while the “off” subgroup receives a 20% off coupon. In this manner, the partner is “in front” of all users for the entire month, but at somewhat lower cost to the partner than offering a major offer to all users for the entire month.

Of course, the method 600 can be run on one or more computers, servers, a server cloud, or other computing device, which can be running multiple offers simultaneously. The provider may have tens or hundreds of offers running simultaneously in the app or on their website, each with individual start and end times.

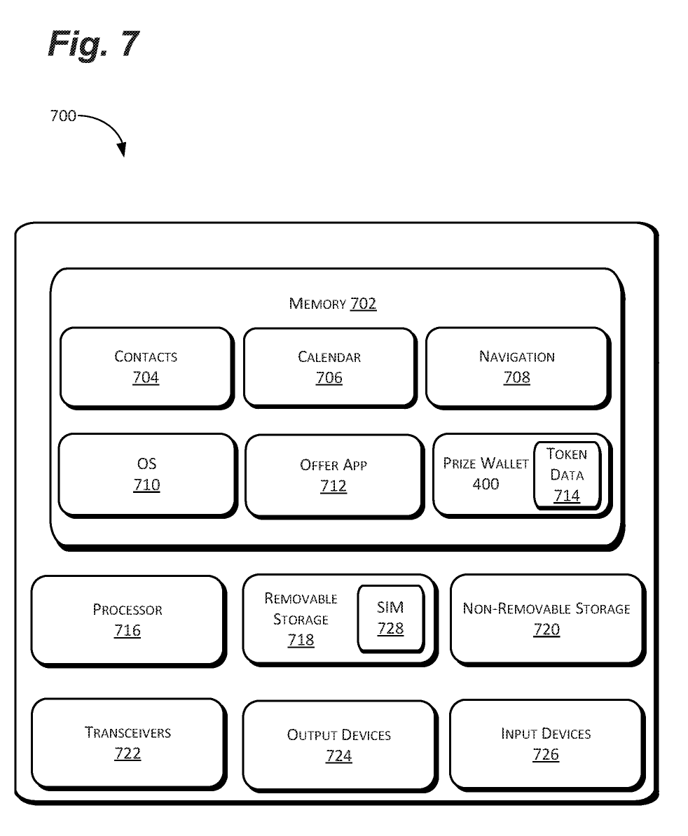

FIG. 7 is a component level view of an electronic device 700 for use with the systems and methods disclosed herein. In some examples, the electronic device 700 can comprise the aforementioned UE 700, which can comprise a cell phone, smart phone, tablet, are a laptop or desktop computer, among other things. The UE 700 can include an app and/or a web browser to enable the user to access the offers supplied by the provider, to maintain their prize wallet 400, etc.

The UE 700 can comprise a number of components to execute the above-mentioned functions. As discussed below, the UE 700 can comprise memory 702 including many common features such as, for example, the contacts 704, calendar 706, navigation software 708, and the operating system (OS) 710. In this case, the UE can also comprise an offer app 712, the prize wallet 400, and token data 714. Notably, the prize wallet 400 and token data 714 may be part of, or stored in, the offer app 712. The UE 700 can also comprise one or more processors 716 and one or more of removable storage 718, non-removable storage 720, transceiver(s) 722, output device(s) 724, and input device(s) 726. In some examples, such as for cellular communication devices, the UE 700 can also include a subscriber identification module (SIM) 728 including an International Mobile Subscriber Identity (IMSI), and other relevant information.

In various implementations, the memory 702 can be volatile (such as random access memory (RAM)), non-volatile (such as read only memory (ROM), flash memory, etc.), or some combination of the two. The memory 702 can include all, or part, of the functions 704, 706, 708 and the OS 710 for the UE 700, among other things.

The memory 702 can also comprise contacts 704, which can include names, numbers, addresses, and other information about the user's business and personal acquaintances, among other things. In some examples, the memory 702 can also include a calendar 706, or other software, to enable the user to track appointments and calls, schedule meetings, and provide similar functions. In some examples, the memory 702 can also comprise navigation software 708 such as global positioning system (GPS) and/or cellular location based navigation systems. Of course, the memory 702 can also include other software such as, for example, e-mail, text messaging, social media, and utilities (e.g., calculators, clocks, compasses, etc.).

The memory 702 can also include the OS 710. Of course, the OS 710 varies depending on the manufacturer of the UE 700 and currently comprises, for example, iOS 10.3.2 for Apple products and Oreo for Android products. The OS 710 contains the modules and software that supports a computer's basic functions, such as scheduling tasks, executing applications, and controlling peripherals.

The UE can also include the offer app 712. The offer app 712 can enable the UE 700 to receive offers from the provider and for the user to review, claim, and redeem offers (or rather, receive the information required to redeem). The offer app 712 can be stored in the memory 702, as shown, or can be web based. Regardless, the offer app 712 can include the various GUIs 200, 220, 240 and other components of the system.

In some examples, the UE 700 can also include the prize wallet 400. As discussed above, the prize wallet 400 can store the user's past and present offers, tokens 242, and other information related to the system. In some examples, as mentioned above, once the user accepts and offer, the offer can be placed in the user's prize wallet 400 to enable the user to actually redeem the offer.

To this end, in some examples, the prize wallet 400 can also include token data 714 associated with each offer that has been claimed. Thus, the token data 714 can be stored in an encrypted file, for example, and can include tokens 242, public/private keys, passwords, and other information to enable the user to redeem the offer. In some examples, the token 242 can be stored in the token data 714 and can be provided to the user on the third GUI 240 in the form of a coupon or a bar code, for example, for redemption purposes.

The UE 700 can also comprise one or more processors 716. In some implementations, the processor(s) 716 can be a central processing unit (CPU), a graphics processing unit (GPU), or both CPU and GPU, or any other sort of processing unit. The UE 700 can also include one or more of removable storage 718, non-removable storage 720, transceiver(s) 722, output device(s) 724, and input device(s) 726. In some examples, such as for cellular communication devices, the UE 700 can also include a subscriber identification module (SIM) 728 including an International Mobile Subscriber Identity (IMSI), and other relevant information.

The UE 700 may also include additional data storage devices (removable and/or non-removable) such as, for example, magnetic disks, optical disks, or tape. Such additional storage is illustrated in FIG. 7 by removable storage 718 and non-removable storage 720. The removable storage 718 and non-removable storage 720 can store some, or all, of the functions 400, 704, 706, 708, 712, 714 and/or OS 710.

Non-transitory computer-readable media may include volatile and nonvolatile, removable and non-removable tangible, physical media implemented in technology for storage of information, such as computer readable instructions, data structures, program modules, or other data. The memory 702, removable storage 718, and non-removable storage 720 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile disks (DVD) or other optical storage, magnetic cassettes, magnetic tape, magnetic disk storage or other magnetic storage devices, or any other tangible, physical medium which can be used to store the desired information and which can be accessed by the UE 700. Any such non-transitory computer-readable media may be part of the UE 700 or may be a separate database, databank, remote server, or cloud-based server.

In some implementations, the transceiver(s) 722 include any sort of transceivers known in the art. In some examples, the transceiver(s) 722 can include wireless modem(s) to facilitate wireless connectivity with the other UE, the Internet, and/or an intranet via a cellular connection. Further, the transceiver(s) 722 may include a radio transceiver that performs the function of transmitting and receiving radio frequency communications via an antenna (e.g., Wi-Fi or Bluetooth®). In other examples, the transceiver(s) 722 may include wired communication components, such as a wired modem or Ethernet port, for communicating with the other UE or the provider's Internet-based network.

In some implementations, the output device(s) 724 include any sort of output devices known in the art, such as a display (e.g., a liquid crystal or thin-film transistor (TFT) display), a touchscreen display, speakers, a vibrating mechanism, or a tactile feedback mechanism. In some examples, the output devices can play various sounds based on, for example, whether the UE 700 is connected to a network, the type of call being received (e.g., video calls vs. voice calls), the number of active calls, etc. In some examples, the output device(s) 724 can provide a sound or message when the UE 700 is unable to connect to a base station, for example, or when the UE 700 uses a secondary frequency as opposed to a primary frequency. Output device(s) 724 also include ports for one or more peripheral devices, such as headphones, peripheral speakers, or a peripheral display.

In various implementations, input device(s) 726 include any sort of input devices known in the art. For example, the input device(s) 726 may include a camera, a microphone, a keyboard/keypad, or a touch-sensitive display. A keyboard/keypad may be a standard push button alphanumeric, multi-key keyboard (such as a conventional QWERTY keyboard), virtual controls on a touchscreen, or one or more other types of keys or buttons, and may also include a joystick, wheel, and/or designated navigation buttons, or the like.

As shown in FIG. 8, the systems and methods disclosed herein can also be used in conjunction with the reward engine 800, which can include a variety of electronic devices. As mentioned above, the various components of the methods 100, 500, 600 such as, for example, approving claims, maintaining user databases, etc. Though an actual reward engine 800 may comprise a cloud of servers or multiple network entities (e.g., a Proxy-Call Session Control Function (PCSCF) or Policy Charging and Rules Function (PCRF)), for ease of explanation, the reward engine 800 is discussed below simply as a server 800. One of skill in the art will nonetheless recognize that the various components of the systems and methods described herein could be located in various other components of the cellular network, on the UE 700, or on a dedicated server. Thus, the server 800 is intended only to simplify the discussion and not to limit the disclosure. The server 800 can comprise, for example, a network entity, a dedicated server, desktop, laptop, tablet, or another type of computing device.

The server 800 can comprise a number of components to execute the above-mentioned functions and apps. As discussed below, the server 800 can comprise memory 802 including many common features such as, for example, the OS 804, the offer app or website 806, and offer data 808. The server 800 can also comprise one or more processors 810. In some implementations, the processor(s) 810 can be a central processing unit (CPU), a graphics processing unit (GPU), or both CPU and GPU, or any other sort of processing unit. The server 800 can also include one or more of removable storage 812, non-removable storage 814, transceiver(s) 816, output device(s) 818, and input device(s) 820.

In various implementations, the memory 802 can be volatile (such as RAM), non-volatile (such as ROM, flash memory, etc.), or some combination of the two. The memory 802 can include all, or part, of the functions 806, 808 for the server 800, among other things. The memory 802 can also include the OS 804. Of course, the OS 804 varies depending on the manufacturer of the server 800 and the type of component. Many servers, for example, run Linux or Windows Server. Dedicated cellular routing servers may run specific telecommunications OSs 804. The OS 804 contains the modules and software that supports a computer's basic functions, such as scheduling tasks, executing applications, and controlling peripherals.

In some examples, the server 800 can also include the offer app/website 806. The offer app/website 806 can comprise a web-based app that can be run in conjunction with the UE 700, but is largely hosted and maintained on the server. This may reduce processor power and power consumption requirements on the UE 700 and can also centralize the offer and claiming process. Instead, or in addition, the offer app/website 806 can also include a website that can be accessed via the Internet, an intranet, or via the provider's existing website. So, for example, the user may log in to their account on the provider's main website and then have access to the offer app/website 806 via a tab or button there.

To this end, the server 800 can also maintain offer data 808 to enable the server 800 to maintain the offer distribution and redemption process. Thus, the server can maintain the details of each offer including, for example, how many of a particular offer have been claimed or remain, the expiration date for the offers, a MDR for each offer, etc. In some examples, the offer data 808 can also include one or more lists of subgroups to enable offers to be distributed as desired (e.g., in a staggered manner, to only a certain subset of customers, etc.). In some examples, the offer data 808 can also include a database of the offers each user has claimed and/or redeemed. Thus, the offer data 808 can include each user's prize wallet 400, for example, or a copy thereof.

The server 800 may also include additional data storage devices (removable and/or non-removable) such as, for example, magnetic disks, optical disks, or tape. Such additional storage is illustrated in FIG. 8 by removable storage 812 and non-removable storage 814. The removable storage 812 and non-removable storage 814 can store some, or all, of the OS 804 and functions 806, 808.

Non-transitory computer-readable media may include volatile and nonvolatile, removable and non-removable tangible, physical media implemented in technology for storage of information, such as computer readable instructions, data structures, program modules, or other data. The memory 802, removable storage 812, and non-removable storage 814 are all examples of non-transitory computer-readable media. Non-transitory computer-readable media include, but are not limited to, RAM, ROM, EEPROM, flash memory or other memory technology, CD-ROM, DVDs or other optical storage, magnetic cassettes, magnetic tape, magnetic disk storage or other magnetic storage devices, or any other tangible, physical medium which can be used to store the desired information and which can be accessed by the server 800. Any such non-transitory computer-readable media may be part of the server 800 or may be a separate database, databank, remote server, or cloud-based server.

In some implementations, the transceiver(s) 816 include any sort of transceivers known in the art. In some examples, the transceiver(s) 816 can include wireless modem(s) to facilitate wireless connectivity with the other UE, the Internet, and/or an intranet via a cellular connection. Further, the transceiver(s) 816 may include a radio transceiver that performs the function of transmitting and receiving radio frequency communications via an antenna (e.g., Wi-Fi or Bluetooth®). In other examples, the transceiver(s) 816 may include wired communication components, such as a wired modem or Ethernet port, for communicating with the other UE or the provider's Internet-based network.

In some implementations, the output device(s) 818 include any sort of output devices known in the art, such as a display (e.g., a liquid crystal or thin-film transistor (TFT) display), a touchscreen display, speakers, a vibrating mechanism, or a tactile feedback mechanism. In some examples, the output devices can play various sounds based on, for example, whether the server 800 is connected to a network, the type of call being received (e.g., video calls vs. voice calls), the number of active calls, etc. Output device(s) 818 also include ports for one or more peripheral devices, such as headphones, peripheral speakers, or a peripheral display.

In various implementations, input device(s) 820 include any sort of input devices known in the art. For example, the input device(s) 820 may include a camera, a microphone, a keyboard/keypad, or a touch-sensitive display. A keyboard/keypad may be a standard push button alphanumeric, multi-key keyboard (such as a conventional QWERTY keyboard), virtual controls on a touchscreen, or one or more other types of keys or buttons, and may also include a joystick, wheel, and/or designated navigation buttons, or the like.

While several possible examples are disclosed above, examples of the present disclosure are not so limited. For instance, while the systems and methods above are discussed with reference to use with cellular communications, the systems and methods can be used with other types of wired and wireless communications. In addition, while various functions are discussed as being performed on a reward engine 800 and/or by an offer app 712 on the UE 700, other components could perform the same or similar functions without departing from the spirit of the invention. In addition, while the disclosure is primarily directed to offers for promotional purposes, it is equally applicable to other operations, such as rationing emergency supplies, selling tickets, or other similar functions.

Such changes are intended to be embraced within the scope of this disclosure. The presently disclosed examples, therefore, are considered in all respects to be illustrative and not restrictive. The scope of the disclosure is indicated by the appended claims, rather than the foregoing description, and all changes that come within the meaning and range of equivalents thereof are intended to be embraced therein.

What is claimed is:

1. A method comprising:
receiving, at a transceiver of a reward engine, a first offer from a first partner for distribution by a provider;
receiving, at the transceiver of the reward engine, at least a date range, a maximum distribution rate (MDR), or both a date range and an MDR for the first offer provided by the first partner;
receiving, at the transceiver of the reward engine, a second offer from a second partner for distribution by the provider;
calculating, with a processor of the reward engine, an actual distribution rate (ADR) for the first offer based at least in part on the MDR, the date range, or both;
dividing a list of a total number of users associated with the provider into a plurality of subgroups, wherein the number of subgroups is based at least in part on the ADR;
sending, with a transceiver of a reward engine, a first plurality of offers for the first offer to a first subgroup of the plurality of subgroups in a first time period;
sending, with the transceiver of the reward engine, a second plurality of offers for the second offer to a second subgroup of the plurality of subgroups in the first time period;
sending, with the transceiver of a reward engine, a third plurality of offers for the second offer to the first subgroup in a second time period; and
sending, with the transceiver of the reward engine, a fourth plurality of offers for the first offer to the second subgroup in the second time period.

2. The method of claim 1, wherein the MDR comprises a maximum number of first offers during the first time period; and
wherein calculating the ADR comprises dividing the total number of users on the list by the maximum number of first offers during the first time period.

3. The method of claim 1, wherein calculating the ADR comprises dividing the total number of users on the list by a number of weeks in the date range.

4. The method of claim 1, further comprising:
receiving, at the transceiver of the reward engine, a request from a first UE in the first subgroup to claim the first offer;
determining, with the processor of the reward engine, that the request was made within the first time period;
determining, with the processor of the reward engine, that the first UE has not previously requested the first offer; and
sending, with the transceiver of the reward engine, a first signal to the first UE to cause the first UE to download a first token to a prize wallet stored in a memory of the first UE, the first token redeemable for the first offer.

5. The method of claim 1, wherein the second subgroup comprises a total number of users associated with the provider minus the first subgroup.

6. The method of claim 1, further comprising:
receiving, at the transceiver of the reward engine, a request within the first time period from a first UE in the second subgroup to claim the first offer;
determining, with the processor of the reward engine, that the request from the first UE is invalid; and
sending, with the transceiver of the reward engine, a first signal to the first UE to cause the first UE to display an error message.

7. A method comprising:
receiving, at a transceiver of a reward engine, a request from a first user equipment (UE) to claim a first offer at a first time;
retrieving, with a processor of the reward engine from an offer database, a date range, and a subgroup associated with the first offer;
determining, with a processor of the reward engine, that the first offer is not located in a first prize wallet associated with the first UE;
retrieving, with a processor of the reward engine, a subgroup associated with the first UE from the offer database;
determining, with the processor, that the subgroup associated with the UE and the date range is valid for the first offer; and
sending, with the transceiver of the reward engine, a first signal to the first UE to cause the first UE to download a first token to the first prize wallet, the first token redeemable for the first offer.

8. The method of claim 7, further comprising:
receiving, at the transceiver of the reward engine, a request from a second UE to claim the first offer at a second time;
determining, with a processor of the reward engine, that the first offer is not located in a second prize wallet associated with the second UE;
retrieving, with a processor of the reward engine, a subgroup associated with the second UE from the offer database;
determining, with the processor, that the date range is invalid for the first offer; and
sending, with the transceiver of the reward engine, a second signal to the second UE to cause the UE to display an error message.

9. The method of claim 7, further comprising:
receiving, at the transceiver of the reward engine, a request from a second UE to claim the first offer at a second time;
determining, with a processor of the reward engine, that the first offer is not located in a second prize wallet associated with the second UE;
retrieving, with a processor of the reward engine, a subgroup associated with the second UE from the offer database;
determining, with the processor, that the subgroup associated with the second UE is invalid for the first offer; and
sending, with the transceiver of the reward engine, a second signal to the second UE to cause the UE to display an error message.

10. The method of claim 9, further comprising:
receiving, at the transceiver of the reward engine, a request from a second UE to claim the first offer at a third time;
determining, with a processor of the reward engine, that the first offer is not located in a second prize wallet associated with the second UE;
retrieving, with a processor of the reward engine, a subgroup associated with the second UE from the offer database;
determining, with the processor, that the subgroup associated with the second UE is valid for the first offer; and
sending, with the transceiver of the reward engine, a third signal to the second UE to cause the second UE to download a second token to the second prize wallet, the second token redeemable for the first offer.

11. The method of claim 7, further comprising:
receiving, at the transceiver of the reward engine, a request from a second UE to claim the first offer at a second time;
determining, with a processor of the reward engine, that the first offer is located in a second prize wallet associated with the second UE; and
sending, with the transceiver of the reward engine, a second signal to the second UE to cause the UE to display an error message.

12. The method of claim 7, wherein the first token comprises a bar code, quick response (QR) code, or alphanumeric code.

13. The method of claim 7, further comprising:
reducing a total number of first offers available by one in response to sending the first token to the first UE;
wherein a predetermined number of first offers are available to claim.

14. A user equipment (UE) comprising:
one or more transceivers to send and receive one or more wireless transmissions;
memory storing at least a graphical user interface (GUI) and a prize wallet;
a display for displaying at least the GUI and receiving one or more inputs from a user; and
one or more processors in communication with at least the one or more transceivers and the memory, the memory including computer executable instructions to cause the UE to:
receive, with the one or more transceivers from a reward engine of a provider, a first offer with a first date range;
receive, with the one or more transceivers from the reward engine of the provider, a second offer with a second date range;
display, with the display, the first offer and the second offer in the GUI;
receive, with the display, a selection of the first offer by the user via the GUI;
determine, with the one or more processors, that the first offer is not located in the prize wallet; and
send, with the one or more transceivers, a first signal requesting the first offer from the reward engine of the provider.

15. The UE of claim 14, wherein the first signal is sent within the first date range, the computer executable instructions further causing the UE to:
receive, with the one or more transceivers, a second signal from the reward engine in response to the first signal;
download, with the one or more transceivers, a first token from the reward engine, the first token redeemable for the first offer; and
display, with the display, a graphical representation of the first token in the GUI.

16. The UE of claim 15, wherein the graphical representation comprises a bar code.

17. The UE of claim 15, wherein the graphical representation comprises a graphical representation of a coupon.

18. The UE of claim 15, wherein the graphical representation comprises an alphanumeric redemption code.

19. The UE of claim 14, wherein the first signal is not sent within the first date range, the computer executable instructions further causing the UE to:
receive, with the one or more transceivers, a second signal from the reward engine in response to the first signal; and
display, with the display, an error message to the user on the GUI.

20. The UE of claim 14, computer executable instructions further causing the UE to:
receive, with the display, a selection of the second offer by the user via the GUI;
determine, with the one or more processors, that the second offer is located in the prize wallet; and
display, with the display, an error message indicating the second offer has already been claimed.
